(19) United States
(12) Patent Application Publication
(10) Pub. No.: US 2025/0048353 A1
(43) Pub. Date: Feb. 6, 2025

(54) RESOURCE ALLOCATION METHOD, DEVICE, AND READABLE STORAGE MEDIUM

(71) Applicant: VIVO MOBILE COMMUNICATION CO., LTD., Dongguan (CN)

(72) Inventors: Dongru LI, Dongguan (CN); Kai WU, Dongguan (CN)

(73) Assignee: VIVO MOBILE COMMUNICATION CO., LTD., Dongguan (CN)

(21) Appl. No.: 18/920,852

(22) Filed: Oct. 19, 2024

Related U.S. Application Data
(63) Continuation of application No. PCT/CN2023/089271, filed on Apr. 19, 2023.

(30) Foreign Application Priority Data
Apr. 22, 2022 (CN) 202210432221.0

(51) Int. Cl. H04W 72/1263; H04W 72/0453

(52) U.S. Cl. CPC H04W 72/1263; H04W 72/0453

(57) ABSTRACT

This application discloses a resource allocation method, a device, and a readable storage medium. The resource allocation method includes: configuring, by a network side device, a resource used for transmitting a backscatter communication BSC channel or signal; and scheduling, by the network side device, transmission of the BSC channel or signal. The BSC channel or signal includes one or more of the following: a carrier wave CW channel or signal, a control channel or signal, or a feedback channel or signal.

### CROSS-REFERENCE TO RELATED APPLICATIONS

This application is a continuation of International Application No. PCT/CN2023/089271, filed on Apr. 19, 2023, which claims priority to Chinese Patent Application No. 202210432221.0, filed on Apr. 22, 2022. The entire contents of each of the above-referenced applications are expressly incorporated herein by reference.

### TECHNICAL FIELD

This application relates to the field of communication technologies, and in particular, to a resource allocation method, a device, and a readable storage medium.

### BACKGROUND

Backscatter communication (BSC) means that a backscatter communication device performs signal modulation by using a radio frequency signal in another device or an environment to transmit information. The backscatter communication device may be a tag device or a passive-Internet of Things (Passive-IoT) device in conventional Radio Frequency Identification (RFID).

Currently, a BSC-related service is not considered in a resource configuration in New Radio (NR), and transmission of the BSC service in an NR system cannot be supported.

### SUMMARY

Embodiments of this application provide a resource allocation method, a device, and a readable storage medium.

According to a first aspect, a resource allocation method is provided, including:
configuring, by a network side device, a resource used for transmitting a BSC channel or signal; and
scheduling, by the network side device, transmission of the BSC channel or signal; where
the BSC channel or signal includes one or more of the following:
a carrier wave CW channel or signal;
a control channel or signal; and
a feedback channel or signal.

According to a second aspect, a resource allocation method is provided, including:
obtaining, by a terminal, resource information used for transmitting a BSC channel or signal; and
transmitting, by the terminal, the BSC channel or signal based on the obtained resource information of the BSC channel or signal; where
the BSC channel or signal includes one or more of the following:
a carrier wave CW channel or signal;
a control channel or signal; and
a feedback channel or signal.

According to a third aspect, a resource allocation apparatus is provided, including:
a configuration module, configured to configure, by a network side device, a resource used for transmitting a BSC channel or signal; and
a scheduling module, configured to schedule, by the network side device, transmission of the BSC channel or signal; where
the BSC channel or signal includes one or more of the following:
a carrier wave CW channel or signal;
a control channel or signal; and
a feedback channel or signal.

According to a fourth aspect, a resource allocation apparatus is provided, including:
an obtaining module, configured to obtain, by a terminal, resource information used for transmitting a BSC channel or signal; and
a transmission module, configured to transmit, by the terminal, the BSC channel or signal based on the obtained resource information of the BSC channel or signal; where
the BSC channel or signal includes one or more of the following:
a carrier wave CW channel or signal;
a control channel or signal; and
a feedback channel or signal.

According to a fifth aspect, a network side device is provided. The network side device includes a processor and a memory, the memory stores a program or an instruction that can be run on the processor, and when the program or the instruction is executed by the processor, the steps of the method according to the first aspect are implemented.

According to a sixth aspect, a network side device is provided, including a processor and a communication interface. The processor is configured to: configure, by a network side device, a resource used for transmitting a backscatter communication BSC channel or a signal; and
schedule, by the network side device, transmission of the BSC channel or signal; where
the BSC channel or signal includes one or more of the following:
a carrier wave CW channel or signal;
a control channel or signal; and
a feedback channel or signal.

According to a seventh aspect, a terminal is provided. The terminal includes a processor and a memory, the memory stores a program or an instruction that can be run on the processor, and when the program or the instruction is executed by the processor, the steps of the method according to the second aspect are implemented.

According to an eighth aspect, a terminal is provided, including a processor and a communication interface. The processor is configured to: obtain, by a terminal, resource information used for transmitting a BSC channel or a signal; and
transmit, by the terminal, the BSC channel or signal based on the obtained resource information of the BSC channel or signal; where
the BSC channel or signal includes one or more of the following:
a carrier wave CW channel or signal;
a control channel or signal; and
a feedback channel or signal.

According to a ninth aspect, a readable storage medium is provided. The readable storage medium stores a program or an instruction, and when the program or the instruction is executed by a processor, the steps of the method according to the first aspect are implemented, or the steps of the method according to the second aspect are implemented.

According to a tenth aspect, a chip is provided. The chip includes a processor and a communication interface. The communication interface is coupled to the processor, and the processor is configured to run a program or instructions, to implement the steps of the method according to the first aspect, or the steps of the method according to the second aspect.

According to an eleventh aspect, a computer program product/program product is provided. The computer program product/program product is stored in a storage medium, and the computer program/program product is executed by at least one processor to implement the steps of the method according to the first aspect or the steps of the method according to the second aspect.

### BRIEF DESCRIPTION OF DRAWINGS

FIG. 1a is a block diagram of a wireless communication system according to an embodiment of this application;

FIG. 1b is a schematic diagram of a transmitting/receiving procedure of a Tag in BSC communication;

FIG. 1c is a first schematic diagram of an application scenario of BSC communication;

FIG. 1d is a second schematic diagram of an application scenario of BSC communication;

FIG. 1e is a third schematic diagram of an application scenario of BSC communication;

FIG. 1f is a schematic diagram of an architecture of BSC communication;

FIG. 2 is a first schematic flowchart of a resource allocation method according to an embodiment of this application;

FIG. 3a is a first schematic diagram of an application scenario according to an embodiment of this application;

FIG. 3b is a second schematic diagram of an application scenario according to an embodiment of this application;

FIG. 3c is a third schematic diagram of an application scenario according to an embodiment of this application;

FIG. 3d is a fourth schematic diagram of an application scenario according to an embodiment of this application;

FIG. 4 is a second schematic flowchart of a resource allocation method according to an embodiment of this application;

FIG. 5 is a first schematic diagram of a structure of a resource allocation apparatus according to an embodiment of this application;

FIG. 6 is a second schematic diagram of a structure of a resource allocation apparatus according to an embodiment of this application;

FIG. 7 is a schematic diagram of a structure of a communication device according to an embodiment of this application;

FIG. 8 is a schematic diagram of a structure of a network side device according to an embodiment of this application; and

FIG. 9 is a schematic diagram of a structure of a terminal according to an embodiment of this application.

### DETAILED DESCRIPTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specific order or sequence. It should be understood that, the terms used in such a way are interchangeable in proper circumstances, so that the embodiments of this application can be implemented in an order other than the order illustrated or described herein. Objects classified by “first” and “second” are usually of a same type, and a quantity of objects is not limited. For example, there may be one or more first objects. In addition, in the description and the claims, “and/or” represents at least one of connected objects, and a character “/” generally represents an “or” relationship between associated objects.

It should be noted that technologies described in the embodiments of this application are not limited to a Long Term Evolution (LTE)/LTE-Advanced (LTE-A) system, and may be further applied to other wireless communication systems such as Code Division Multiple Access (CDMA), Time Division Multiple Access (TDMA), Frequency Division Multiple Access (FDMA), Orthogonal Frequency Division Multiple Access (OFDMA), Single-carrier Frequency Division Multiple Access (SC-FDMA), and other systems. The terms “system” and “network” in the embodiments of this application may be used interchangeably. The technologies described can be applied to both the systems and the radio technologies mentioned above as well as to other systems and radio technologies. A NR system is described in the following description for illustrative purposes, and the NR terminology is used in most of the following description, although these technologies can also be applied to applications other than the NR system application, such as the 6th Generation (6G) communication system.

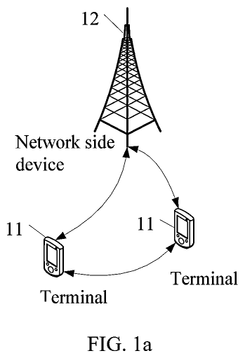

FIG. 1a is a block diagram of a wireless communication system to which the embodiments of this application are applicable. The wireless communication system includes a terminal 11 and a network side device 12. The terminal 11 may be a terminal side device such as a mobile phone, a tablet personal computer, a laptop computer that is also referred to as a notebook computer, a Personal Digital Assistant (PDA), a palmtop computer, a netbook, an Ultra-Mobile Personal Computer (UMPC), a Mobile Internet Device (MID), an Augmented Reality (AR)/Virtual Reality (VR) device, a robot, a wearable device, Vehicle User Equipment (VUE), Pedestrian User Equipment (PUE), a smart home device (a home device with a wireless communication function, such as a refrigerator, a television, a washing machine, or furniture), a game console, a Personal Computer (PC), a teller machine, or a self-service machine. The wearable device includes a smart watch, a smart band, a smart headset, smart glasses, smart jewelry (a smart bangle, a smart bracelet, a smart ring, a smart necklace, a smart anklet bracelet, a smart anklet chain, or the like), a smart wrist strap, a smart dress, and the like. It should be noted that a specific type of the terminal 11 is not limited in the embodiments of this application. The network side device 12 may include an access network device or a core network device. The access network device may also be referred to as a radio access network device, a Radio Access Network (RAN), a radio access network function, or a radio access network unit. The access network device may include a base station, a Wireless Local Area Networks (WLAN) access point, a WiFi node, and the like. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home evolved NodeB, a Transmission Reception Point (TRP), or another proper term in the art. The base station is not limited to a specific technical vocabulary provided that a same technical effect is achieved. It should be noted that in the embodiments of this application, a base station in an NR system is merely used as an example for description, but does not limit a specific type of the base station. The core network device may include but is not limited to at least one of the following: a core network node, a core network function, a Mobility Management Entity (MME), an Access and Mobility Management Function (AMF), a Session Management Function (SMF), a User Plane Function (UPF), a Policy Control Function (PCF), a Policy and Charging Rules Function (PCRF), an Edge Application Server Discovery Function (EASDF), Unified Data Management (UDM), Unified Data Repository (UDR), a Home Subscriber Server (HSS), Centralized Network Configuration (CNC), a Network Repository Function (NRF), a Network Exposure Function (NEF), a Local NEF (L-NEF), a Binding Support Function (BSF), an Application Function (AF), and the like. It should be noted that, in the embodiments of this application, only a core network device in an NR system is used as an example for description, and a specific type of the core network device is not limited.

For better understanding of the solution provided in this application, the following content is described first:

### BSC

Backscatter communication means that a backscatter communication device performs signal modulation by using a radio frequency signal in another device or an environment to transmit information. The backscatter communication device may be a tag or a Passive-IoT in conventional RFID. The backscatter communication device controls a reflection coefficient I of a circuit by adjusting internal impedance of the backscatter communication device, to change an amplitude, a frequency, a phase, and the like of an incident signal, thereby implementing signal modulation. A reflection coefficient of a signal may be represented as:

$$Γ = \frac{{Z}_{1} - {Z}_{0}}{{Z}_{1} + {Z}_{0}} = \vert Γ \vert {e}^{j {θ}_{T}}$$

Z₀ is antenna characteristic impedance, and Z₁ is load impedance. It is assumed that the incident signal is Sᵢₙ (t). In this case, an output signal is Sₒᵤₜ(t)=Sᵢₙ(t)|Γ|e^{jθ}^{_{T}}. Therefore, corresponding amplitude modulation, frequency modulation, or phase modulation can be implemented through proper control of the reflection coefficient.

Information transmission between a reader (reader) in the RFID and the Tag:

Instructions for operations of the Reader are shown in Table 1.

TABLE 1

| Operation type | Instruction | Function |
|---|---|---|
| Select | Select | Select a tag |
| Inventory | Query | Start an inventory action |
| | | Generate a random number to |
| | | determine response time |
| | Query Adjust | Adjust a quantity of |
| | | original slots of a tag |
| | Query Repeat | Tags are reduced by a |
| | (QueryRep) | quantity of slots of the tags |
| | EPC acknowledgment | A reader responds to an |
| | (ACK) | instruction for a tag |
| | NAK | Instruction sent by the reader |
| | | The tag returns to an arbitrate |
| | | (Arbitrate) state |
| Access | Random request | The tag is required to |
| | (Req_RN) | generate a random number |
| | Read | Read data from a location |
| | | in stored tags |
| | Write | Write the data to the |
| | | stored tags |
| | Kill | No more response |
| | | to any reader |
| | | Prevent privacy leakage |
| | | The tag cannot be used again |
| | Lock | No more writing action can be |
| | | performed on the tag |
| | | Prevent the data from being |
| | | tampered with at random |
| | Access (optional) | When the tag has a password, |
| | | change the tag open |
| | | from an (Secure) |
| | | (Open) state to a secure |
| | | state |
| | BlockWrite (optional) | Write multiple blocks at a time |
| | Lock Erase (optional) | Multiple blocks are cleared |
| | | from stored single tags |

States of the Tag are shown in Table 2.

TABLE 2

| Tag states | Description |
|---|---|
| Ready | Not in a current inventory operation |
| Arbitrate | This tag is currently in a specific inventory operation |
| | Indicating a number of a slot is not 0 and is still |
| | waiting |
| Reply | Generate a 16-bit random number to the reader |
| | A state in which acknowledgment is performed when |
| | one ACK message is received |
| | Return to an arbitrate state when no ACK message is |
| | received |
| Acknowledge | Enter any state other than a killed state from this state |
| Open | An instruction of a random request is received when a |
| | tag whose password is not zero is in an |
| | acknowledgment state |
| Secure | A tag whose password is zero is received when an |
| | instruction of a random request sent by the reader is |
| | received in the acknowledgment state |
| Killed | Permanently unavailable |

Transmitting/receiving procedure

As shown in FIG. 1b, a current protocol of an Ultra High Frequency (UHF) RFID is designed in an inventory mode, and a reader is required to send a query instruction (Query), and a tag responds with a reply (Reply), that is, generates a 16-bit random number to a reader. Then, after the reader sends the sequence to the Tag by using an ACK instruction, the Tag sends related data to the reader.

Two types of application scenarios of backscatter

(1) Cellular backscatter scenario-no assistance from a terminal, as shown in FIG. 1c.

(2) Cellular backscatter scenario assisted by a terminal, as shown in FIG. 1d and FIG. 1e. In FIG. 1d, a terminal receives feedback information sent by a Tag. In FIG. 1e, the terminal sends a Carrier Wave (CW) and a signaling command or control to the Tag. A signaling type includes at least one of the following: select, inventory, and access. A network receives feedback information of the Tag.

For example, a system architecture of backscatter includes multiple types shown in FIG. 1f.

A resource allocation method provided in embodiments of this application is described in detail below with reference to the accompanying drawings by using some embodiments and application scenarios thereof.

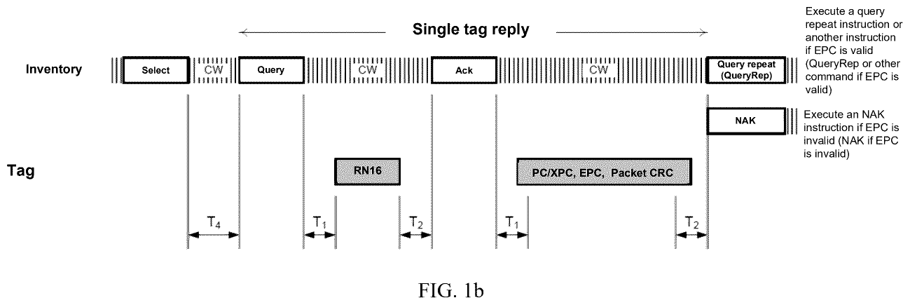

As shown in FIG. 2, an embodiment of this application provides a resource allocation method that includes the following steps:

Step 201: A network side device configures a resource used for transmitting a BSC channel or signal.

Step 202: The network side device schedules transmission of the BSC channel or signal.

In an embodiment, an entity that transmits the BSC channel or signal may include at least one of the network side device, a Tag, and a terminal.

It should be noted that transmission in the embodiments of this application may include sending or receiving.

In this embodiment of this application, the network side device configures the resource used for transmitting the BSC channel or signal, and the network side device schedules the transmission of the BSC channel or signal, to allocate a BSC resource, and improve communication reliability of a BSC service.

It should be noted that the method in this embodiment of this application may be applied to a BSC scenario between a Tag and a gNB shown in FIG. 1f, or a BSC communication scenario between a Tag and a gNB in which a terminal participates.

The BSC channel or signal includes one or more of the following:

(1) A carrier wave channel or signal. For example, the carrier wave CW channel or signal includes an excitation signal, which may be referred to as CW for short. In an embodiment, the carrier wave CW channel or signal may be information sent by the network side device to a tag, or may be information sent by a terminal to a tag. In some embodiments, the carrier wave CW channel or signal may further include a data channel that is referred to as a shared channel.

(2) A control channel or signal, for example, a select signal, a query signal, a query repeat signal, a reply signal, a read signal, a write signal, or a random request signal, which may be referred to as a command for short. In an embodiment, the control channel or signal may be information sent by the network side device to a tag, or may be information sent by a terminal to a tag.

(3) A feedback channel or signal, for example, Tag identification information (such as a 16-bit random number that temporarily represents a Tag identity in a query process), electronic product code information, and Tag status information, which may be referred to as feedback for short. In an embodiment, the feedback channel or signal may be information sent by a tag to a terminal through backscatter, or may be information sent by a tag to the network side device through backscatter.

In a possible implementation, that a network side device configures a resource used for transmitting a BSC channel or signal includes:
the network side device configures a target frequency band used for transmitting the BSC channel or signal.

The target frequency band may also be referred to as a target band.

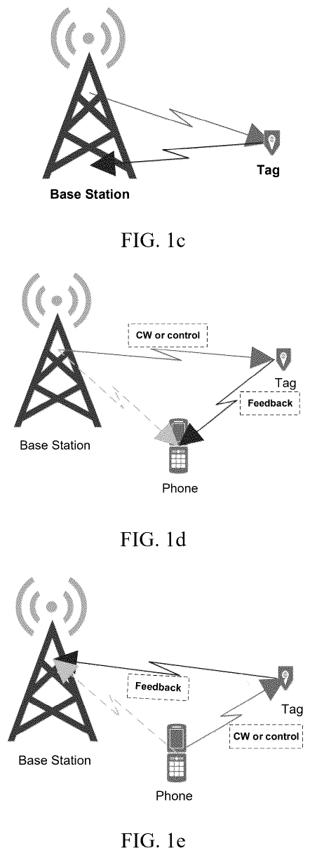

In this embodiment of this application, the network side device deploys BSC on a band of a specific mobile communication system. For example, an NR system allocates a new band to a BSC service, which may be shown in FIG. 3a.

In a possible implementation, that a network side device configures a resource used for transmitting a BSC channel or signal includes:
the network side device configures a center frequency used for transmitting the BSC channel or signal.

In this embodiment of this application, a network specifies a center frequency of BSC. For example, the network may indicate the center frequency of the BSC in an Absolute Radio Frequency Channel Number (ARFCN) manner. In addition, in one case, a specific frequency domain resource size may be not configured, but may be determined by using a specific hardware radio frequency-related implementation.

In a possible implementation, that a network side device configures a resource used for transmitting a BSC channel or signal includes:
the network side device configures a target carrier or a target serving cell used for transmitting the BSC channel or signal.

In this embodiment of this application, the network side device configures a specific carrier or a serving cell for BSC, which may be shown in FIG. 3b. For example, the network side device configures a dedicated secondary cell for BSC to transmit the BSC channel or signal.

In some embodiments, the target carrier or the target serving cell is only used for BSC transmission.

It should be noted that BSC transmission mentioned above and below refers to transmission of the BSC channel or signal.

Further, that the network side device schedules transmission of the BSC channel or signal includes:
the network side device schedules the BSC channel or signal to be transmitted on the target carrier or the target serving cell by using a target control signaling. The target control signaling is a signaling sent by the network side device on a carrier or a serving cell that is not used for BSC transmission, or the target control signaling is a signaling sent by the network side device on the target carrier or the target serving cell.

The target control signaling may be Radio Resource Control (RRC) signaling, a Media Access Control-Control Element (MAC CE), or downlink control information DCI.

In an optional implementation, the network side device triggers data transmission on a serving cell specific to BSC in a manner of crossing carrier scheduling.

In an optional implementation, the network side device schedules BSC transmission on a specific carrier or serving cell by sending RRC, a MAC CE, or DCI in a serving cell that is not used for BSC. For example, the network side device sends DCI in a cell 1 to schedule BSC transmission in a cell dedicated to BSC. In other words, the network side device schedules BSC transmission by cross carrier scheduling.

In a possible implementation, that a network side device configures a resource used for transmitting a BSC channel or signal includes:
the network side device configures a target Bandwidth Part (BWP) used for transmitting the BSC channel or signal, where the target BWP includes a target uplink BWP and/or a target downlink BWP.

It should be noted that the target part bandwidth used for transmitting the BSC channel or signal is referred to as a BSC BWP below, the target uplink BWP is a BSC Uplink (UL) BWP, and the target downlink BWP is a BSC Downlink (DL) BWP.

In some embodiments, the target BWP is used for BSC transmission only.

In this embodiment of this application, the network side device configures a specific BWP for BSC, and the BSC BWP includes at least one of the BSC DL BWP and the BSC UL BWP, which may be shown in FIG. 3c.

Further, a configuration of the target BWP does not include one or more of the following:
(1) a Physical Downlink Control Channel (PDCCH)-related configuration;
(2) a Physical Downlink Shared Channel (PDSCH)-related configuration;
(3) a Physical Uplink Shared Channel (PUSCH)-related configuration;
(4) a Physical Uplink Control Channel (PUCCH)-related configuration; and
(5) a reference signal-related configuration.

Further, the configuration of the target BWP includes one or more of the following:
(1) an identifier ID of the target BWP;
(2) a bandwidth of the target BWP;
(3) a Sub-Carrier Spacing (SCS) of the target BWP; and
(4) a related configuration of the BSC channel or signal.

In this embodiment of this application, a PDCCH, a PDSCH, and the like may not be configured on the BSC BWP, and there is only a channel/signal configuration related to transmission of a BSC service. In other words, in content configured on a BWP in a related technology, except for content related to BSC transmission, an original configuration of an NR channel/signal may be omitted and not configured.

For example, the configuration of the target BWP may not include at least one of the following configurations:
pdsch-configCommon (including a Cell specific parameter), pdcch-config (including a UE specific parameter), pdsch-config (including a UE specific parameter), SPS-config (used for a single BWP, where an NW may release SPS-config at any time), radioLinkMonitoringConfig (used for detect cellular and beam radio link faults), RACH-configCommon pucch-configCommon (including a Cell specific parameter), pusch-configCommon (including a Cell specific parameter), pucch-config (including a UE specific parameter), pusch-config (including a UE specific parameter), CG-config, beamFailureRecoveryConfig, and SRS-config.

Further, the method further includes:
(1) activating or applying the target BWP, and starting a first timer (a first timer); and
(2) after the expiry of the first timer, the network side device switches to a preconfigured BWP.

In this embodiment of this application, in a case of switching to a BSC BWP, a BWP-fallback timer (that is, the first timer) is started, and the network side device switches back to the preconfigured BWP after the expiry of the timer. In an embodiment, the terminal can have only one activated BWP in one serving cell at a same moment. Therefore, if the terminal applies the BSC BWP to work, that is, a currently activated BWP is the BSC BWP, because parameters such as a PDCCH are not configured on the BSC BWP, the terminal cannot receive, on the BSC BWP, signaling sent by the network side device to return to a BWP for transmitting the PDCCH and a PDSCH. Therefore, in a case that the first timer expires, the terminal may return to the preconfigured BWP by using a configuration of the first timer, where the preconfigured BWP is the BWP for transmitting the PDCCH and the PDSCH.

In some embodiments, the network side device activates or applies both the target BWP and another BWP that is a non-target BWP.

In this embodiment of this application, the BSC BWP and a non-BSC BWP (for example, a BWP used for transmitting a physical channel) may be activated or applied at the same time. Therefore, in this embodiment, an objective of simultaneously transmitting a BSC service and an existing mobile communication service (for example, an NR communication service) can be implemented. It should be noted that in an embodiment, a BSC service transmitted on the BSC BWP is received by an additional receiver in a receiving device (for example, a terminal). The additional receiver refers to another receiver that is different from a receiver that receives a mobile communication channel or signal such as a PDCCH or a PDSCH in a related technology, and may be understood as a receiver that is used to receive the BSC service.

For example, the BSC service is transmitted on the BSC BWP by obtaining network scheduling signaling on the non-BSC BWP.

In a possible implementation, that a network side device configures a resource used for transmitting a BSC channel or signal includes:
the network side device configures the BSC channel or signal to be transmitted on a first BWP, where the first BWP is further used for first transmission, and the first transmission is used to transmit a channel or signal other than the BSC channel or signal.

In some embodiments, the first transmission may be used for transmitting a channel or a signal including at least one of the following: a PDSCH, a Synchronization Signal and PBCH Block (SSB), a Channel State Information-Reference Signal (CSI-RS), a Sounding Reference Signal (SRS), a Physical Random Access Channel (PRACH), a Physical Uplink Control Channel (PUCCH), and a Physical Uplink Shared Channel (PUSCH). In an example, the channel or signal, other than the BSC channel or signal, used for transmission is an NR channel or signal.

In this embodiment of this application, BSC transmission and NR transmission may be configured on a same BWP (that is, the first BWP), that is, BSC transmission and NR transmission are supported to be performed on one BWP. It should be noted that NR transmission is merely used as an example of the first transmission for description herein. In some embodiments, it may be understood that the first transmission may be LTE transmission or other transmission used for transmitting a channel or signal other than the BSC channel or signal. A type of the first transmission is not specifically limited in this embodiment of this application. For all subsequent descriptions of an example related to the first transmission, NR transmission is used as an example for description, and details are not described again.

Further, the first BWP is a BWP with a specific BWP index. In other words, the network configures BSC to be transmitted on a BWP with a specified BWP ID.

Further, that the network side device configures the BSC channel or signal to be transmitted on the first BWP includes:
the network side device configures the BSC channel or signal to be transmitted on a target frequency domain resource of the first BWP. In other words, the network is configured to perform BSC transmission on a specific frequency domain resource of the first BWP.

In an embodiment, the specific frequency domain resource may include a specific Resource Block set (RB set) (which may be multiple consecutive RBs) and a specific RB. For example, it is agreed that BSC is transmitted on an RB with an RB ID-0 on the first BWP, that is, the network side device allocates RBO on the first BWP for BSC transmission.

In a possible implementation, that the network side device schedules transmission of the BSC channel or signal includes at least one of the following:

(1) The network side device schedules the transmission of the BSC channel or signal by sending Downlink Control Information (DCI) signaling.

In this embodiment of this application, the network side device sends DCI to UE, and dynamically schedules transmission of the BSC by using the DCI. For example, if a carrier indicated by a Carrier Indicator Field (CIF) in the DCI is a carrier for BSC transmission, an information field subsequent to the CIF in the DCI is redefined to indicate information about a parameter (for example, a BSC resource allocation parameter) related to transmission of the BSC service.

(2) The network side device schedules the transmission of the BSC channel or signal by configuring semi-persistent transmission.

In an embodiment, a network side configures at least one semi-persistent transmission configuration, and indicates, by using signaling such as DCI, to activate one or more semi-static configurations, so that the terminal is scheduled to transmit or receive the BSC channel or signal in a transmission opportunity of the activated one or more semi-static configurations.

With reference to any one or more of the foregoing embodiments, in a possible implementation, the related configuration parameter of the transmission of the BSC channel or signal includes one or more of the following:
(1) power information (for example, Transmit Power Control (TPC) information);
(2) a frequency domain resource, for example, frequency domain resource parameters include a frequency domain resource size, a frequency domain resource start location, and the like;
(3) a bandwidth;
(4) a time domain resource, for example, time domain resource parameters include a time domain resource length, a time domain resource start location, and the like;
(5) a resource cycle, for example, if the resource cycle is 10 ms, it indicates that there is a resource for one BSC transmission every 10 ms;
(6) duration occupied by a resource in each resource cycle;
(7) a waveform, which refers to a waveform used for BSC transmission, such as an On-Off Keying (OOK) waveform;
(8) a sending timeline for the BSC channel or signal, which refers to a time gap requirement that sending of the BSC channel or signal needs to be met; where for example, sending of the BSC channel or signal requires a period of preparation time, and in this case, after receiving a signaling for scheduling the sending of the BSC channel or signal, the BSC channel or signal needs to be sent after a time gap greater than or equal to the preparation time;
(9) a receiving timeline for the BSC channel or signal, which refers to a time gap requirement that receiving of the BSC channel or signal needs to be met; where for example, receiving of the BSC channel or signal requires a period of decoding time, and in this case, after receiving the BSC channel or signal, a HARQ corresponding to the BSC channel or signal can be sent only after a time gap greater than or equal to the decoding time; and
(10) Hybrid Automatic Repeat request-ACK (HARQ-ACK) resource information corresponding to the BSC channel or signal.

In a possible implementation, the transmission of the BSC channel or signal and the first transmission satisfy at least one of Time Division Multiplexing (TDM) and Frequency Division Multiplexing (FDM). The first transmission is used to transmit a channel or signal other than a BSC channel or signal, which may be shown in FIG. 3d.

In a possible implementation, in a case that the transmission of the BSC channel or signal and the first transmission satisfy TDM or satisfy TDM and FDM, a time gap between the transmission of the BSC channel or signal and the first transmission is greater than or equal to a first threshold.

In other words, in a case that the transmission of the BSC channel or signal and the first transmission satisfy TDM or satisfy TDM and FDM, the time gap between the BSC transmission and the first transmission is greater than or equal to a specific value.

In a case that the transmission of the BSC channel or signal and the first transmission satisfy FDM or satisfy TDM and FDM, a frequency domain interval between the transmission of the BSC channel or signal and the first transmission is greater than or equal to a second threshold.

In other words, in a case that the transmission of the BSC channel or signal and the first transmission satisfy FDM or satisfy TDM and FDM, the frequency domain interval between the BSC transmission and the first transmission is greater than or equal to a specific value.

In a possible implementation, the method further includes:
interruption time exists in a process of switching between the transmission of the BSC channel or signal and the first transmission, and the network side device does not perform data transmission within the interruption time.

For example, there is specific interruption time in a process of switching between the BSC transmission and NR transmission. In the interruption time, it may be assumed that the terminal or the network side device does not send or receive data. One reason for the foregoing switching process is that the terminal does not support simultaneous execution of the BSC transmission and the first transmission.

In a possible implementation, before the network side device configures the resource used for transmitting the BSC channel or signal, the method further includes:
the network side device receives first capability information sent by the terminal.

The first capability information includes one or more of the following:
(1) whether the terminal supports performing the transmission of the BSC channel or signal and the first transmission simultaneously, where the first transmission is used for transmitting a channel or signal other than the BSC channel or signal, for example, whether the terminal supports simultaneous transmitting/receiving of an NR channel/signal and the BSC channel/signal;
(2) a radio frequency RF capability of the terminal, where the RF capability is used to indicate a quantity of transceiver chains supported by the terminal;
(3) a receiver capability of the terminal, where the receiver capability includes at least one of whether multiple receivers are supported and a quantity of supported receivers. The receiver may include a primary receiver and an additional receiver, such as a low power consumption receiver. For example, the BSC channel or signal and the NR channel/signal are sent/received by different transmitters/receivers. For example, the BSC channel or signal is received by the low power consumption receiver.

In a possible implementation, in a case that the terminal does not support performing the transmission of the BSC channel or signal and the first transmission simultaneously, the transmission of the BSC channel or signal and the first transmission satisfy TDM, or the transmission of the BSC channel or signal and the first transmission satisfy TDM and FDM. It may be understood that in a case that the terminal does not support simultaneous transmitting/receiving of the two sets of channels or signals, the transmission of the BSC channel or signal and the first transmission cannot be executed in an FDM manner.

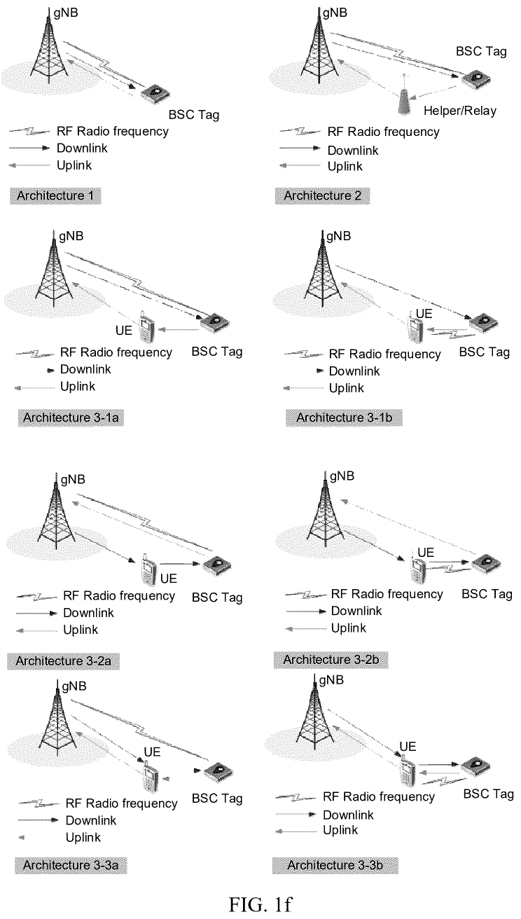

As shown in FIG. 4, an embodiment of this application provides a resource allocation method that includes the following steps:

Step 401: A terminal obtains resource information used for transmitting a BSC channel or signal.

Step 402: The terminal transmits the BSC channel or signal based on the obtained resource information of the BSC channel or signal.

It should be noted that transmission in the embodiments of this application may include sending or receiving.

In this embodiment of this application, the terminal obtains the resource information used for transmitting the BSC channel or signal. For example, the resource information may be obtained from a network side device, that is, the network side device configures a resource used for transmitting the BSC channel or signal and provides the resource to the terminal, so that the terminal subsequently transmits the BSC channel or signal.

It should be noted that the method in this embodiment of this application may be applied to a BSC communication scenario between a Tag and a gNB in which the terminal is involved, as shown in FIG. 1f.

It should be noted that parameters, information, and the like indicated in method descriptions on a terminal side are the same as detailed descriptions provided in the method description on a network side, and details are not described herein again.

The BSC channel or signal includes one or more of the following:

(1) A carrier wave CW channel or signal. For example, the carrier wave CW channel or signal includes an excitation signal, which may be referred to as CW for short. In an embodiment, the carrier wave CW channel or signal may be information sent by the network side device to a tag, or may be information sent by a terminal to a tag. In some embodiments, the carrier wave CW channel or signal may further include a data channel that is referred to as a shared channel.

(2) A control channel or signal, for example, a select signal, a query signal, a query repeat signal, a reply signal, a read signal, a write signal, or a random request signal, which may be referred to as a command for short. In an embodiment, the control channel or signal may be information sent by the network side device to a tag, or may be information sent by a terminal to a tag.

(3) A feedback channel or signal, for example, Tag identification information (such as a 16-bit random number that temporarily represents a Tag identity in a query process), electronic product code information, and Tag status information, which may be referred to as feedback for short. In an embodiment, the feedback channel or signal may be information sent by a tag to a terminal through backscatter, or may be information sent by a tag to the network side device through backscatter.

In a possible implementation, that a terminal obtains resource information used for transmitting a BSC channel or signal includes:
the terminal obtains information about target frequency band used for transmitting the BSC channel or signal.

The target frequency band may also be referred to as a target band.

In a possible implementation, that a terminal obtains resource information used for transmitting a BSC channel or signal includes:
the terminal obtains information about center frequency used for transmitting the BSC channel or signal.

In a possible implementation, that a terminal obtains resource information used for transmitting a BSC channel or signal includes:
the terminal obtains information about a target carrier or a target serving cell used for transmitting the BSC channel or signal.

In some embodiments, the target carrier or the target serving cell is only used for BSC transmission, and the BSC transmission means transmission of the BSC channel or signal.

In a possible implementation, that the terminal transmits the BSC channel or signal based on the obtained resource information of the BSC channel or signal includes:
the terminal transmits the BSC channel or signal on a target carrier or in a target serving cell based on target control signaling, where the target control signaling is a signaling received by the terminal on a carrier or a serving cell that is not used for BSC transmission, or the target control signaling is a signaling received by the terminal on a target carrier or in a target serving cell.

The target control signaling may be RRC signaling, a MAC CE, or DCI.

In a possible implementation, that a terminal obtains resource information used for transmitting a BSC channel or signal includes:
the terminal obtains information about a target bandwidth part BWP used for transmitting the BSC channel or signal, where the target BWP includes a target uplink BWP and/or a target downlink BWP.

It should be noted that the target part bandwidth used for transmitting the BSC channel or signal is referred to as a BSC BWP below, the target uplink BWP is a BSC UL BWP, and the target downlink BWP is a BSC DL BWP.

In some embodiments, the target BWP is used for BSC transmission only.

In a possible implementation, a configuration of the target BWP does not include one or more of the following:
(1) a PDCCH-related configuration;
(2) a PDSCH-related configuration;
(3) a PUSCH-related configuration;
(4) a PUCCH-related configuration; and
(5) a reference signal-related configuration.

In a possible implementation, the configuration of the target BWP includes one or more of the following:
(1) an identifier ID of the target BWP;
(2) a bandwidth of the target BWP;
(3) an SCS of the target BWP; and
(4) a related configuration of the BSC channel or signal.

In this embodiment of this application, a PDCCH, a PDSCH, and the like may not be configured on the BSC BWP, and there is only a channel/signal configuration related to transmission of a BSC service. In other words, in content configured on a BWP in a related technology, except for content related to BSC transmission, an original configuration of an NR channel/signal may be omitted and not configured.

For example, the following related configurations may be removed from a BWP configuration in a related technology:
pdsch-configCommon (including a Cell specific parameter), pdcch-config (including a UE specific parameter), pdsch-config (including a UE specific parameter), SPS-config (used for a single BWP, where an NW may release SPS-config at any time), radioLinkMonitoringConfig (used for detect cellular and beam radio link faults), RACH-configCommon pucch-configCommon (including a Cell specific parameter), pusch-configCommon (including a Cell specific parameter), pucch-config (including a UE specific parameter), pusch-config (including a UE specific parameter), CG-config, beamFailureRecoveryConfig, and SRS-config.

In a possible implementation, that a terminal obtains resource information used for transmitting a BSC channel or signal includes:
the terminal obtains information about a first BWP, where the first BWP is used for transmitting the BSC channel or signal, the first BWP is further used for first transmission, and the first transmission is used for transmitting a channel or signal other than the BSC channel or signal.

In some embodiments, the first transmission may be used for transmitting a channel or signal including at least one of the following: a PDSCH, an SSB, a CSI-RS, an SRS, a PRACH, a PUCCH, and a PUSCH. In an example, the channel or signal, other than the BSC channel or signal, used for transmission is an NR channel or signal.

In a possible implementation, the first BWP is a BWP with a specific BWP index.

In a possible implementation, that the terminal obtains information about a first BWP includes:
the terminal obtains information about a target frequency domain resource on the first BWP, where the target frequency domain resource is used for transmitting the BSC channel or signal. In other words, the terminal performs BSC transmission on a specific frequency domain resource of the first BWP.

In an embodiment, the specific frequency domain resource may include a specific RB set (which may be multiple consecutive RBs) and a specific RB. For example, it is agreed that BSC is transmitted on an RB with an RB ID=0 on the first BWP, that is, the network side device allocates RBO on the first BWP for BSC transmission.

In a possible implementation, that the terminal transmits the BSC channel or signal includes at least one of the following:

(1) The terminal transmits the BSC channel or signal based on DCI signaling sent by a network side device.

In this embodiment of this application, the network side device sends DCI to UE, and dynamically schedules transmission of the BSC by using the DCI. For example, if a carrier indicated by a CIF in the DCI is a carrier for BSC transmission, an information field subsequent to the CIF in the DCI is redefined to indicate information about a parameter (for example, a BSC resource allocation parameter) related to transmission of the BSC service.

(2) The terminal transmits the BSC channel or signal based on semi-persistent transmission configured by the network side device.

In an embodiment, a network side configures at least one semi-persistent transmission configuration, and indicates, by using signaling such as DCI, to activate one or more semi-static configurations, so that the terminal is scheduled to transmit or receive the BSC channel or signal in a transmission opportunity of the activated one or more semi-static configurations.

With reference to any one or more of the foregoing embodiments, in a possible implementation, the related configuration parameter of the transmission of the BSC channel or signal includes one or more of the following:
(1) power information (for example, TPC information);
(2) a frequency domain resource, for example, frequency domain resource parameters include a frequency domain resource size, a frequency domain resource start location, and the like;
(3) a bandwidth;
(4) a time domain resource, for example, time domain resource parameters include a time domain resource length, a time domain resource start location, and the like;
(5) a resource cycle, for example, if the resource cycle is 10 ms, it indicates that there is a resource for one BSC transmission every 10 ms;
(6) duration occupied by a resource in each resource cycle;
(7) a waveform, which refers to a waveform used for BSC transmission, such as an OOK waveform;
(8) a sending timeline for the BSC channel or signal, which refers to a time gap requirement that sending of the BSC channel or signal needs to be met; where for example, sending of the BSC channel or signal requires a period of preparation time, and in this case, after receiving a signaling for scheduling the sending of the BSC channel or signal, the BSC channel or signal needs to be sent after a time gap greater than or equal to the preparation time;
(9) a receiving timeline for the BSC channel or signal, which refers to a time gap requirement that receiving of the BSC channel or signal needs to be met; where for example, receiving of the BSC channel or signal requires a period of decoding time, and in this case, after receiving the BSC channel or signal, a HARQ corresponding to the BSC channel or signal can be sent only after a time gap greater than or equal to the decoding time; and
(10) HARQ-ACK resource information corresponding to the BSC channel or signal.

In a possible implementation, the transmission of the BSC channel or signal and first transmission satisfy at least one of TDM and FDM, and the first transmission is used for transmitting a channel or signal other than the BSC channel or signal.

In a possible implementation, in a case that the transmission of the BSC channel or signal and the first transmission satisfy TDM or satisfy TDM and FDM, a time gap between the transmission of the BSC channel or signal and the first transmission is greater than or equal to a first threshold.

In other words, in a case that the transmission of the BSC channel or signal and the first transmission satisfy TDM or satisfy TDM and FDM, the time gap between the BSC transmission and the first transmission is greater than or equal to a specific value.

In a case that the transmission of the BSC channel or signal and the first transmission satisfy FDM or satisfy TDM and FDM, a frequency domain interval between the transmission of the BSC channel or signal and the first transmission is greater than or equal to a second threshold.

In other words, in a case that the transmission of the BSC channel or signal and the first transmission satisfy FDM or satisfy TDM and FDM, the frequency domain interval between the BSC transmission and the first transmission is greater than or equal to a specific value.

In a possible implementation, the method further includes:
interruption time exists in a process of switching between the transmission of the BSC channel or signal and the first transmission, and the terminal does not perform data transmission within the interruption time.

For example, there is specific interruption time in a process of switching between the BSC transmission and NR transmission. In the interruption time, it may be assumed that the terminal or the network side device does not send or receive data. One reason for the foregoing switching process is that the terminal does not support simultaneous execution of the BSC transmission and the first transmission.

In a possible implementation, before the terminal obtains a resource that is configured by the network side device and that is used for transmitting the BSC channel or signal, the method further includes:
the terminal sends first capability information to the network side device, where the first capability information includes one or more of the following:
(1) whether the terminal supports performing the transmission of the BSC channel or signal and the first transmission simultaneously, where the first transmission is used for transmitting a channel or signal other than the BSC channel or signal;
(2) an RF capability of the terminal, where the RF capability is used to indicate a quantity of transceiver chains supported by the terminal; and
(3) a receiver capability of the terminal, where the receiver capability includes at least one of whether multiple receivers are supported and a quantity of supported receivers.

In a possible implementation, in a case that the terminal does not support performing the transmission of the BSC channel or signal and the first transmission simultaneously, the transmission of the BSC channel or signal and the first transmission satisfy TDM, or the transmission of the BSC channel or signal and the first transmission satisfy TDM and FDM.

The resource allocation method provided in the embodiments of this application may be performed by a resource allocation apparatus. In the embodiments of this application, the resource allocation apparatus provided in the embodiments of this application is described by using an example in which the resource allocation apparatus performs the resource allocation method.

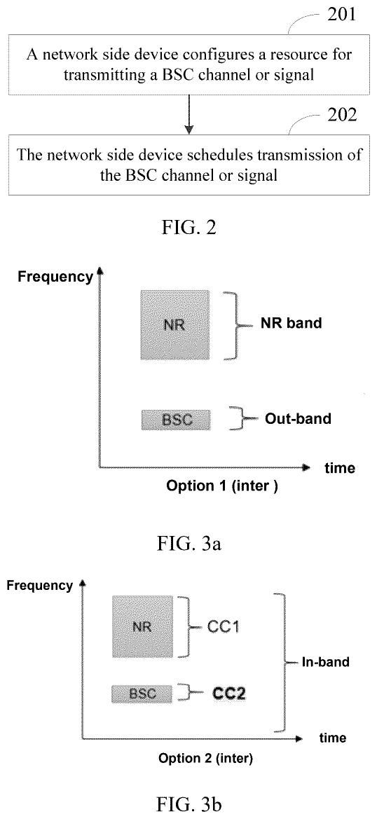

As shown in FIG. 5, an embodiment of this application further provides a resource allocation apparatus 500 that includes:
a configuration module 501, configured to configure, by a network side device, a resource used for transmitting a BSC channel or signal; and
a scheduling module 502, configured to schedule, by the network side device, transmission of the BSC channel or signal; where
the BSC channel or signal includes one or more of the following:
a carrier wave CW channel or signal;
a control channel or signal; and
a feedback channel or signal.

In some embodiments, the configuration module 501 is configured to:
configure, by the network side device, a target frequency band used for transmitting the BSC channel or signal.

In some embodiments, the configuration module 501 is configured to:
configure, by the network side device, a center frequency used for transmitting the BSC channel or signal.

In some embodiments, the configuration module 501 is configured to:
configure, by the network side device, a target carrier or a target serving cell used for transmitting the BSC channel or signal.

In some embodiments, the scheduling module 502 is configured to:
schedule, by the network side device, the BSC channel or signal to be transmitted on the target carrier or the target serving cell by using a target control signaling, where the target control signaling is a signaling sent by the network side device on a carrier or a serving cell that is not used to transmit the BSC channel or signal, or the target control signaling is a signaling sent by the network side device on the target carrier or the target serving cell.

In some embodiments, the configuration module 501 is configured to:
configure, by the network side device, a target bandwidth part BWP used for transmitting the BSC channel or signal, where the target BWP includes a target uplink BWP and/or a target downlink BWP.

In some embodiments, a configuration of the target BWP does not include one or more of the following:
a physical downlink control channel PDCCH-related configuration;
a physical downlink shared channel PDSCH-related configuration;
a physical uplink shared channel PUSCH-related configuration;
a physical uplink control channel PUCCH-related configuration; and
a reference signal-related configuration.

In some embodiments, the configuration of the target BWP includes one or more of the following:
an identifier ID of the target BWP;
a bandwidth of the target BWP;
a subcarrier spacing SCS of the target BWP; and
a related configuration of the BSC channel or signal.

In some embodiments, the apparatus further includes:
a starting module, configured to activate or apply the target BWP and start a first timer; and
a switching module, configured to: after the expiry of the first timer, switch, by the network side device, to a preconfigured BWP.

In some embodiments, the network side device activates or applies both the target BWP and another BWP that is a non-target BWP.

In some embodiments, the configuration module 501 is configured to:
configure, by the network side device, the BSC channel or signal to be transmitted on a first BWP, where the first BWP is further used for first transmission, and the first transmission is used for transmitting a channel or signal other than the BSC channel or signal.

In some embodiments, the first BWP is a BWP with a specific BWP index.

In some embodiments, the configuration module 501 is configured to:
configure, by the network side device, the BSC channel or signal to be transmitted on a target frequency domain resource of the first BWP.

In some embodiments, the scheduling module 502 is configured to perform at least one of the following:
scheduling, by the network side device, the transmission of the BSC channel or signal by sending DCI signaling; and
scheduling, by the network side device, the transmission of the BSC channel or signal by configuring semi-persistent transmission.

In some embodiments, a related configuration parameter for transmission of the BSC channel or signal includes one or more of the following:
power information;
a frequency domain resource;
a bandwidth;
a time domain resource;
a resource cycle;
duration of a resource in each resource cycle;
a waveform;
a sending timeline of the BSC channel or signal;
a receiving timeline of the BSC channel or signal; and
hybrid automatic repeat request acknowledgement HARQ-ACK resource information corresponding to the BSC channel or signal.

In some embodiments, the transmission of the BSC channel or signal and the first transmission satisfy at least one of time division multiplexing TDM and frequency division multiplexing FDM, and the first transmission is used for transmitting a channel or signal other than the BSC channel or signal.

In some embodiments, in a case that the transmission of the BSC channel or signal and the first transmission satisfy TDM or satisfy TDM and FDM, a time gap between the transmission of the BSC channel or signal and the first transmission is greater than or equal to a first threshold; and
in a case that the transmission of the BSC channel or signal and the first transmission satisfy FDM or satisfy TDM and FDM, a frequency domain interval between the transmission of the BSC channel or signal and the first transmission is greater than or equal to a second threshold.

In some embodiments, interruption time exists in a process of switching between the transmission of the BSC channel or signal and the first transmission, and the network side device does not perform data transmission within the interruption time.

In some embodiments, the apparatus further includes:
a receiving module, configured to: before the network side device configures a resource used for transmitting the BSC channel or signal, receive, by the network side device, first capability information sent by a terminal, where the first capability information includes one or more of the following:
whether the terminal supports performing the transmission of the BSC channel or signal and first transmission simultaneously, where the first transmission is used for transmitting a channel or signal other than the BSC channel or signal;
a radio frequency RF capability of the terminal, where the RF capability is used to indicate a quantity of transceiver chains supported by the terminal; and
a receiver capability of the terminal, where the receiver capability includes at least one of whether multiple receivers are supported and a quantity of supported receivers.

In some embodiments, in a case that the terminal does not support performing the transmission of the BSC channel or signal and the first transmission simultaneously, the transmission of the BSC channel or signal and the first transmission satisfy TDM, or the transmission of the BSC channel or signal and the first transmission satisfy TDM and FDM.

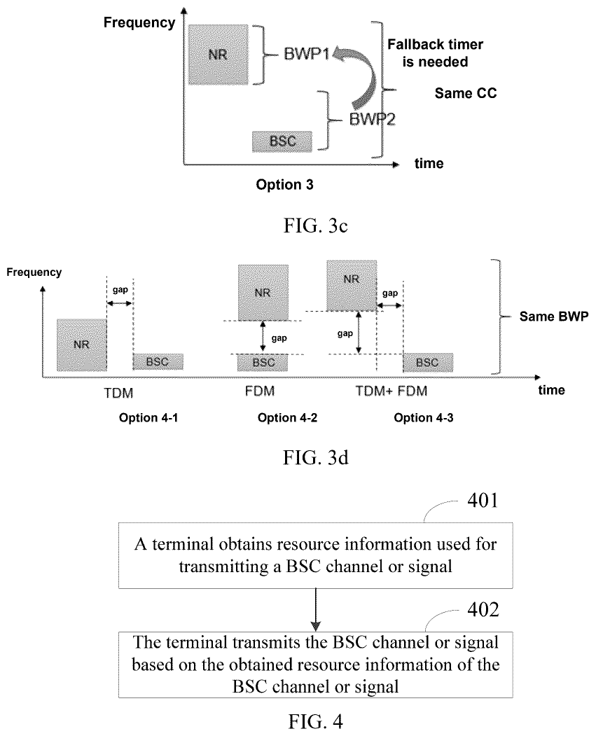

As shown in FIG. 6, an embodiment of this application further provides a resource allocation apparatus 600 that includes:
an obtaining module 601, configured to obtain, by a terminal, resource information used for transmitting a BSC channel or signal; and
a transmission module 602, configured to transmit, by the terminal, the BSC channel or signal based on the obtained resource information of the BSC channel or signal; where the BSC channel or signal includes one or more of the following:
a carrier wave CW channel or signal;
a control channel or signal; and
a feedback channel or signal.

In some embodiments, the obtaining module 601 is configured to:
obtain, by the terminal, information about a target frequency band used for transmitting the BSC channel or signal.

In some embodiments, the obtaining module 601 is configured to:
obtain, by the terminal, information about a center frequency used for transmitting the BSC channel or signal.

In some embodiments, the obtaining module 601 is configured to:
obtain, by the terminal, information about a target carrier or a target serving cell used for transmitting the BSC channel or signal.

In some embodiments, the transmission module 602 is configured to:
transmit, by the terminal, the BSC channel or signal on the target carrier or the target serving cell based on target control signaling, where the target control signaling is a signaling received by the terminal on a carrier or a serving cell that is not used to transmit the BSC channel or signal, or the target control signaling is a signaling received by the terminal on the target carrier or in the target serving cell.

In some embodiments, the obtaining module 601 is configured to:
obtain, by the terminal, information about a target bandwidth part BWP used for transmitting the BSC channel or signal, where the target BWP includes a target uplink BWP and/or a target downlink BWP.

In some embodiments, a configuration of the target BWP does not include one or more of the following:
a PDCCH-related configuration;
a PDSCH-related configuration;
a PUSCH-related configuration;
a PUCCH-related configuration; and
a reference signal-related configuration.

In some embodiments, the configuration of the target BWP includes one or more of the following:
an ID of the target BWP;
a bandwidth of the target BWP;
an SCS of the target BWP; and
a related configuration of the BSC channel or signal.

In some embodiments, the obtaining module 601 is configured to:
obtain, by the terminal, information about a first BWP, where the first BWP is used for transmitting the BSC channel or signal, the first BWP is further used for first transmission, and the first transmission is used for transmitting a channel or signal other than the BSC channel or signal.

In some embodiments, the first BWP is a BWP with a specific BWP index.

In some embodiments, the obtaining module 601 is configured to:
obtain, by the terminal, information about a target frequency domain resource on the first BWP, where the target frequency domain resource is used for transmitting the BSC channel or signal.

In some embodiments, the transmission module 602 is used for at least one of the following:
transmitting, by the terminal, the BSC channel or signal based on DCI signaling sent by a network side device; and
transmitting, by the terminal, the BSC channel or signal based on semi-persistent transmission configured by the MS network side device.

In some embodiments, a related configuration parameter for transmission of the BSC channel or signal includes one or more of the following:
power information;
a frequency domain resource;
a bandwidth;
a time domain resource;
a resource cycle;
duration of a resource in each resource cycle;
a waveform;
a sending timeline of the BSC channel or signal;
a receiving timeline of the BSC channel or signal; and
HARQ-ACK resource information corresponding to the BSC channel or signal.

In some embodiments, the transmission of the BSC channel or signal and the first transmission satisfy at least one of TDM and FDM, and the first transmission is used for transmitting a channel or signal other than the BSC channel or signal.

In some embodiments, in a case that the transmission of the BSC channel or signal and the first transmission satisfy TDM or satisfy TDM and FDM, a time gap between the transmission of the BSC channel or signal and the first transmission is greater than or equal to a first threshold; and
in a case that the transmission of the BSC channel or signal and the first transmission satisfy FDM or satisfy TDM and FDM, a frequency domain interval between the transmission of the BSC channel or signal and the first transmission is greater than or equal to a second threshold.

In some embodiments, interruption time exists in a process of switching between the transmission of the BSC channel or signal and the first transmission, and the terminal does not perform data transmission within the interruption time.

In some embodiments, the apparatus further includes:
a sending module, configured to: before the terminal obtains a resource that is configured by the network side device and that is used for transmitting the BSC channel or signal, send, by the terminal, first capability information to the network side device, where the first capability information includes one or more of the following:
whether the terminal supports performing the transmission of the BSC channel or signal and first transmission simultaneously, where the first transmission is used for transmitting a channel or signal other than the BSC channel or signal;
an RF capability of the terminal, where the RF capability is used to indicate a quantity of transceiver chains supported by the terminal; and
a receiver capability of the terminal, where the receiver capability includes at least one of whether multiple receivers are supported and a quantity of supported receivers.

In some embodiments, in a case that the terminal does not support performing the transmission of the BSC channel or signal and the first transmission simultaneously, the transmission of the BSC channel or signal and the first transmission satisfy TDM, or the transmission of the BSC channel or signal and the first transmission satisfy TDM and FDM.

The resource allocation apparatus in this embodiment of this application may be an electronic device, for example, an electronic device with an operating system, or may be a component in the electronic device, for example, an integrated circuit or a chip. The electronic device may be a terminal, or another device other than the terminal. For example, the terminal may include but is not limited to the foregoing listed types of the terminal 11, and the another device may be a server, a Network Attached Storage (NAS), or the like. This is not specifically limited in this embodiment of this application.

The resource allocation apparatus provided in this embodiment of this application can implement the processes implemented in the method embodiments of FIG. 2 to FIG. 4, and a same technical effect is achieved. To avoid repetition, details are not described herein again.

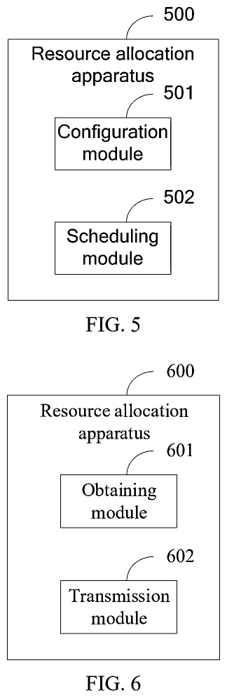

In some embodiments, as shown in FIG. 7, an embodiment of this application further provides a communication device 700, including a processor 701 and a memory 702, and the memory 702 stores a program or an instruction that can be run on the processor 701. For example, in a case that the communication device 700 is a terminal, when the program or the instruction is executed by the processor 701, the steps of the foregoing embodiment of the resource allocation method are implemented, and a same technical effect can be achieved. In a case that the communication device 700 is a network side device, when the program or the instruction is executed by the processor 701, the steps of the foregoing embodiment of the resource allocation method are implemented, and a same technical effect can be achieved. To avoid repetition, details are not described herein again.

An embodiment of this application further provides a network side device, including a processor and a communication interface. The processor is configured to: configure, by the network side device, a resource used for transmitting a backscatter communication BSC channel or a signal; and schedule, by the network side device, transmission of the BSC channel or signal, where the BSC channel or signal includes one or more of the following: a carrier wave CW channel or signal, a control channel or signal, and a feedback channel or signal. This network side device embodiment is corresponding to the foregoing method embodiment of the network side device. Each implementation process and implementation of the foregoing method embodiment may be applicable to this network side device embodiment, and a same technical effect can be achieved.

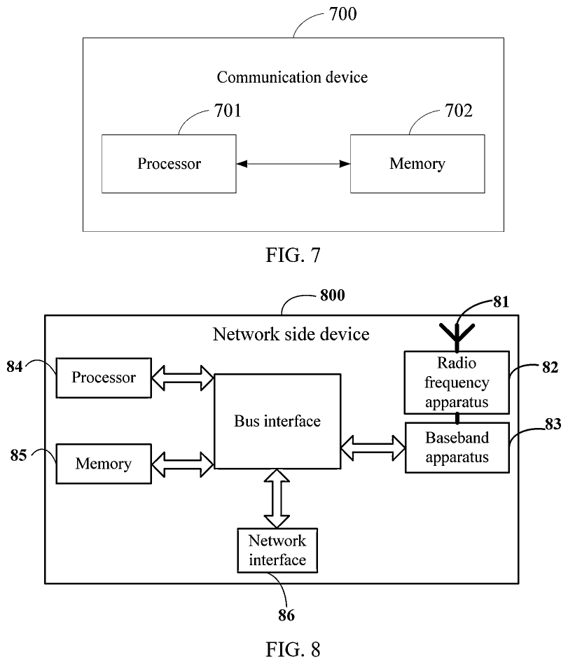

An embodiment of this application further provides a network side device. As shown in FIG. 8, the network side device 800 includes an antenna 81, a radio frequency apparatus 82, a baseband apparatus 83, a processor 84, and a memory 85. The antenna 81 is connected to the radio frequency apparatus 82. In an uplink direction, the radio frequency apparatus 82 receives information through the antenna 81, and sends the received information to the baseband apparatus 83 for processing. In a downlink direction, the baseband apparatus 83 processes information that needs to be sent, and sends processed information to the radio frequency apparatus 82. The radio frequency apparatus 82 processes the received information, and sends processed information through the antenna 81.

In the foregoing embodiment, the method performed by the network side device may be implemented in the baseband apparatus 83. The baseband apparatus 83 includes a baseband processor.

For example, the baseband apparatus 83 may include at least one baseband board. Multiple chips are disposed on the baseband board. As shown in FIG. 8, one chip is, for example, a baseband processor, and is connected to the memory 85 by using a bus interface, to invoke a program in the memory 85 to perform the operations of the network device shown in the foregoing method embodiment.

The network side device may further include a network interface 86, and the interface is, for example, a Common Public Radio Interface (CPRI).

For example, the network side device 800 in this embodiment of this application further includes an instruction or a program that is stored in the memory 85 and that can be run on the processor 84, and the processor 84 invokes the instruction or the program in the memory 85 to perform the method performed by the modules shown in FIG. 5, and a same technical effect is achieved. To avoid repetition, details are not described herein again.

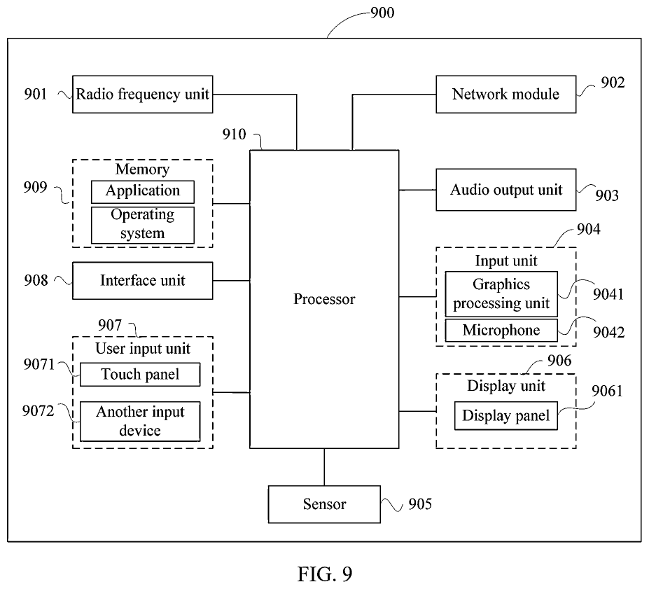

An embodiment of this application further provides a terminal, including a processor and a communication interface. The processor is configured to: obtain, by the terminal, information about a resource used for transmitting a BSC channel or signal; and transmit, by the terminal, the BSC channel or signal based on the obtained resource information of the BSC channel or signal, where the BSC channel or signal includes one or more of the following: a carrier wave CW channel or signal, a control channel or signal, and a feedback channel or signal. The terminal embodiment is corresponding to the method embodiment on the terminal side, each implementation process and implementation of the method embodiment can be applied to the terminal embodiment, and a same technical effect can be achieved. For example, FIG. 9 is a schematic diagram of a hardware structure of a terminal according to an embodiment of this application.

The terminal 900 includes but is not limited to at least a part of components such as a radio frequency unit 901, a network module 902, an audio output unit 903, an input unit 904, a sensor 905, a display unit 906, a user input unit 907, an interface unit 908, a memory 909, and a processor 910.

A person skilled in the art can understand that the terminal 900 may further include a power supply (such as a battery) that supplies power to each component. The power supply may be logically connected to the processor 910 by using a power supply management system, to implement functions such as charging and discharging management, and power consumption management by using the power supply management system. The terminal structure shown in FIG. 9 constitutes no limitation on the terminal, and the terminal may include more or fewer components than those shown in the figure, or combine some components, or have different component arrangements. Details are not described herein.

It should be understood that in this embodiment of this application, the input unit 904 may include a Graphics Processing Unit (GPU) 9041 and a microphone 9042. The graphics processing unit 9041 processes image data of a static picture or a video obtained by an image capture apparatus (for example, a camera) in a video capture mode or an image capture mode. The display unit 906 may include a display panel 9061, and the display panel 9061 may be configured in a form of a liquid crystal display, an organic light-emitting diode, or the like. The user input unit 907 includes at least one of a touch panel 9071 and another input device 9072. The touch panel 9071 is also referred to as a touchscreen. The touch panel 9071 may include two parts: a touch detection apparatus and a touch controller. The another input device 9072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 901 may transmit the downlink data to the processor 910 for processing. In addition, the radio frequency unit 901 may send uplink data to the network side device. Generally, the radio frequency unit 901 includes but is not limited to an antenna, an amplifier, a transceiver, a coupler, a low noise amplifier, a duplexer, and the like.

The memory 909 may be configured to store a software program or an instruction and various data. The memory 909 may mainly include a first storage area for storing a program or an instruction and a second storage area for storing data. The first storage area may store an operating system, and an application or an instruction required by at least one function (for example, a sound playing function or an image playing function). In addition, the memory 909 may be a volatile memory or a non-volatile memory, or the memory 909 may include a volatile memory and a non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synch link DRAM (SLDRAM), and a Direct Rambus RAM (DRRAM). The memory 909 in this embodiment of this application includes but is not limited to these memories and any memory of another proper type.

The processor 910 may include one or more processing units. In some embodiments, an application processor and a modem processor are integrated into the processor 910. The application processor mainly processes an operating system, a user interface, an application, or the like. The modem processor mainly processes a wireless communication signal, for example, a baseband processor. It may be understood that, in some embodiments, the modem processor may not be integrated into the processor 910.

The processor 910 is configured to obtain, by a terminal, resource information used for transmitting a BSC channel or signal.

The processor 910 is configured to transmit the BSC channel or signal based on the obtained resource information of the BSC channel or signal.

The BSC channel or signal includes one or more of the following:
a carrier wave CW channel or signal;
a control channel or signal; and
a feedback channel or signal.

In some embodiments, the processor 910 is configured to:
obtain, by the terminal, information about a target frequency band used for transmitting the BSC channel or signal.

In some embodiments, the processor 9101 is configured to:
obtain, by the terminal, information about a center frequency used for transmitting the BSC channel or signal.

In some embodiments, the processor 9101 is configured to:
obtain, by the terminal, information about a target carrier or a target serving cell used for transmitting the BSC channel or signal.

In some embodiments, the processor 910 is configured to:
transmit, by the terminal, the BSC channel or signal on the target carrier or in the target serving cell based on target control signaling, where the target control signaling is a signaling received by the terminal on a carrier or a serving cell that is not used for the BSC transmission, or the target control signaling is a signaling received by the terminal on the target carrier or in the target serving cell.

In some embodiments, the processor 910 is configured to:
obtain, by the terminal, information about a target bandwidth part BWP used for transmitting the BSC channel or signal, where the target BWP includes a target uplink BWP and/or a target downlink BWP.

In some embodiments, a configuration of the target BWP does not include one or more of the following:
a PDCCH-related configuration;
a PDSCH-related configuration;
a PUSCH-related configuration;
a PUCCH-related configuration; and
a reference signal-related configuration.

In some embodiments, the configuration of the target BWP includes one or more of the following:
an ID of the target BWP;
a bandwidth of the target BWP;
an SCS of the target BWP; and
a related configuration of the BSC channel or signal.

In some embodiments, the processor 910 is configured to:
obtain, by the terminal, information about a first BWP, where the first BWP is used for transmitting the BSC channel or signal, the first BWP is further used for first transmission, and the first transmission is used for transmitting a channel or signal other than the BSC channel or signal.

In some embodiments, the first BWP is a BWP with a specific BWP index.

In some embodiments, the processor 910 is configured to:
obtain, by the terminal, information about a target frequency domain resource on the first BWP, where the target frequency domain resource is used for transmitting the BSC channel or signal.

In some embodiments, the processor 910 is used for at least one of the following:
transmitting, by the terminal, the BSC channel or signal based on DCI signaling sent by a network side device; and
transmitting, by the terminal, the BSC channel or signal based on semi-persistent transmission configured by the Rambus network side device.

In some embodiments, a related configuration parameter for transmission of the BSC channel or signal includes one or more of the following:
power information;
a frequency domain resource;
a bandwidth;
a time domain resource;
a resource cycle;
duration of a resource in each resource cycle;
a waveform;
a sending timeline of the BSC channel or signal;
a receiving timeline of the BSC channel or signal; and
HARQ-ACK resource information corresponding to the BSC channel or signal.

In some embodiments, the transmission of the BSC channel or signal and the first transmission satisfy at least one of TDM and FDM, and the first transmission is used for transmitting a channel or signal other than the BSC channel or signal.

In some embodiments, in a case that the transmission of the BSC channel or signal and the first transmission satisfy TDM or satisfy TDM and FDM, a time gap between the transmission of the BSC channel or signal and the first transmission is greater than or equal to a first threshold; and
in a case that the transmission of the BSC channel or signal and the first transmission satisfy FDM or satisfy TDM and FDM, a frequency domain interval between the transmission of the BSC channel or signal and the first transmission is greater than or equal to a second threshold.

In some embodiments, interruption time exists in a process of switching between the transmission of the BSC channel or signal and the first transmission, and the terminal does not perform data transmission within the interruption time.

In some embodiments, the processor 910 is configured to: before the terminal obtains a resource that is configured by the network side device and that is used for transmitting the BSC channel or signal, send, by the terminal, first capability information to the network side device, where the first capability information includes one or more of the following:
whether the terminal supports performing the transmission of the BSC channel or signal and first transmission simultaneously, where the first transmission is used for transmitting a channel or signal other than the BSC channel or signal;
an RF capability of the terminal, where the RF capability is used to indicate a quantity of transceiver chains supported by the terminal; and
a receiver capability of the terminal, where the receiver capability includes at least one of whether multiple receivers are supported and a quantity of supported receivers.

In some embodiments, in a case that the terminal does not support performing the transmission of the BSC channel or signal and the first transmission simultaneously, the transmission of the BSC channel or signal and the first transmission satisfy TDM, or the transmission of the BSC channel or signal and the first transmission satisfy TDM and FDM.

An embodiment of this application further provides a readable storage medium. The readable storage medium stores a program or an instruction, and when the program or the instruction is executed by a processor, the processes of the foregoing embodiment of the resource allocation method are implemented, and a same technical effect can be achieved. To avoid repetition, details are not described herein again.

The processor is a processor in the terminal in the foregoing embodiments. The readable storage medium includes a computer-readable storage medium, such as a computer read-only memory ROM, a random access memory RAM, a magnetic disk, or an optical disc.

An embodiment of this application further provides a chip. The chip includes a processor and a communication interface, the communication interface is coupled to the processor, and the processor is configured to run a program or an instruction to implement the processes of the foregoing embodiment of the resource allocation method, and a same technical effect can be achieved. To avoid repetition, details are not described herein again.

It should be understood that the chip mentioned in this embodiment of this application may also be referred to as a system-level chip, a system chip, a chip system, or a system on chip.

An embodiment of this application further provides a computer program/program product, the computer program/program product is stored in a storage medium, and the computer program/program product is executed by at least one processor to implement the processes of the foregoing embodiment of the resource allocation method, and a same technical effect can be achieved. To avoid repetition, details are not described herein again.

A person of ordinary skill in the art may be aware that, in combination with the examples described in the embodiments disclosed in this specification, units and algorithm steps may be implemented by using electronic hardware or a combination of computer software and electronic hardware. Whether the functions are performed by hardware or software depends on particular applications and design constraints of the technical solutions. A person skilled in the art may use different methods to implement the described functions for each particular application, but it should not be considered that the implementation goes beyond the scope of the present disclosure.

It can be clearly understood by a person skilled in the art that, for the purpose of convenient and brief description, for a detailed operating process of the foregoing system, apparatus, and unit, refer to a corresponding process in the foregoing method embodiments. Details are not described herein again.

In the embodiments provided in this application, it should be understood that the disclosed apparatus and method may be implemented in other manners. For example, the described apparatus embodiment is merely an example. For example, the unit division is merely logical function division and may be other division in actual implementation. For example, multiple units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on multiple network units. Some or all of the units may be selected based on actual requirements to achieve the objectives of the solutions in the embodiments.

In addition, functional units in the embodiments of the present disclosure may be integrated into one processing unit, or each of the units may exist alone physically, or two or more units are integrated into one unit.

When the functions are implemented in a form of a software functional unit and sold or used as an independent product, the functions may be stored in a computer readable storage medium. Based on such an understanding, the technical solutions of the present disclosure essentially, or the part contributing to the related art, or some of the technical solutions may be implemented in a form of a software product. The computer software product is stored in a storage medium, and includes several instructions for instructing a computer device (which may be a personal computer, a server, a network device, or the like) to perform all or some of the steps of the methods described in the embodiments of the present disclosure. The foregoing storage medium includes: any medium that can store program code, such as a USB flash drive, a removable hard disk, a ROM, a RAM, a magnetic disk, or an optical disc.

A person of ordinary skill in the art may understand that all or some of the processes of the methods in the embodiments may be implemented by a computer program controlling related hardware. The program may be stored in a computer readable storage medium. When the program runs, the processes of the methods in the embodiments are performed. The foregoing storage medium may include: a magnetic disk, an optical disc, a ROM, a RAM, or the like.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the methods and apparatuses in the embodiments of this application is not limited to performing functions in the order shown or discussed, but may also include performing the functions in a basically simultaneous manner or in opposite order based on the functions involved. For example, the described methods may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. In most circumstances, the former is a preferred implementation. Based on such an understanding, the technical solutions of this application essentially or the part contributing to the related art may be implemented in a form of a computer software product. The computer software product is stored in a storage medium (for example, a ROM/RAM, a floppy disk, or an optical disc), and includes several instructions for instructing a terminal (which may be a mobile phone, a computer, a server, an air conditioner, a network device, or the like) to perform the methods described in the embodiments of this application.

The embodiments of this application are described above with reference to the accompanying drawings, but this application is not limited to the foregoing specific implementations, and the foregoing specific implementations are only illustrative and not restrictive. Under the enlightenment of this application, a person of ordinary skill in the art can make many forms without departing from the purpose of this application and the protection scope of the claims, all of which fall within the protection of this application.

1. A resource allocation method, comprising:
configuring, by a network side device, a resource used for transmitting a Backscatter Communication (BSC) channel or signal; and
scheduling, by the network side device, transmission of the BSC channel or signal,
wherein the BSC channel or signal comprises one or more of the following:
a Carrier Wave (CW) channel or signal;
a control channel or signal; or
a feedback channel or signal.

2. The method according to claim 1, wherein the configuring, by the network side device, the resource used for transmitting a BSC channel or signal comprises:
configuring, by the network side device, a target frequency band used for transmitting the BSC channel or signal, or
configuring, by the network side device, a center frequency used for transmitting the BSC channel or signal, or
configuring, by the network side device, a target carrier or a target serving cell used for transmitting the BSC channel or signal.

3. The method according to claim 2, wherein the scheduling, by the network side device, the transmission of the BSC channel or signal comprises:
scheduling, by the network side device, the BSC channel or signal to be transmitted on the target carrier or the target serving cell by using a target control signaling,
wherein the target control signaling is a signaling sent by the network side device on a carrier or a serving cell that is not used to transmit the BSC channel or signal, or the target control signaling is a signaling sent by the network side device on the target carrier or the target serving cell.

4. The method according to claim 1, wherein the configuring, by the network side device, the resource used for transmitting a BSC channel or signal comprises:
configuring, by the network side device, a target Bandwidth Part (BWP) used for transmitting the BSC channel or signal,
wherein the target BWP comprises a target uplink BWP or a target downlink BWP.

5. The method according to claim 4, wherein a configuration of the target BWP comprises one or more of the following:
an identifier ID of the target BWP;
a bandwidth of the target BWP;
a Subcarrier Spacing (SCS) of the target BWP; or
a related configuration of the BSC channel or signal,
or
wherein a configuration of the target BWP does not comprise one or more of the following:
a Physical Downlink Control Channel (PDCCH)-related configuration;
a Physical Downlink Shared Channel (PDSCH)-related configuration;
a Physical Uplink Shared Channel (PUSCH)-related configuration;
a Physical Uplink Control Channel (PUCCH)-related configuration; or
a reference signal-related configuration, or
wherein the method further comprises:
activating or applying the target BWP, and starting a first timer; and
after the expiry of the first timer, switching, by the network side device, to a preconfigured BWP.

6. The method according to claim 4, wherein the network side device simultaneously activates or applies both the target BWP and another BWP.

7. The method according to claim 1, wherein the configuring, by the network side device, the resource used for transmitting a BSC channel or signal comprises:
configuring, by the network side device, the BSC channel or signal to be transmitted on a first BWP,
wherein the first BWP is further used for first transmission, and the first transmission is used for transmitting a channel or signal other than the BSC channel or signal.

8. The method according to claim 7, wherein the first BWP is a BWP with a specific BWP index; or
wherein the configuring, by the network side device, the BSC channel or signal to be transmitted on a first BWP comprises:
configuring, by the network side device, the BSC channel or signal to be transmitted on a target frequency domain resource of the first BWP.

9. The method according to claim 1, wherein the scheduling, by the network side device, transmission of the BSC channel or signal comprises at least one of the following:
scheduling, by the network side device, the transmission of the BSC channel or signal by sending DCI signaling; or
scheduling, by the network side device, the transmission of the BSC channel or signal by configuring semi-persistent transmission,
or
wherein a related configuration parameter for transmission of the BSC channel or signal comprises one or more of the following:
power information;
a frequency domain resource;
a bandwidth;
a time domain resource;
a resource cycle;
duration of a resource in each resource cycle;
a waveform;
a sending timeline of the BSC channel or signal;
a receiving timeline of the BSC channel or signal; or
hybrid automatic repeat request acknowledgement HARQ-ACK resource information corresponding to the BSC channel or signal,
or
wherein the transmission of the BSC channel or signal and the first transmission satisfy at least one of time division multiplexing TDM or frequency division multiplexing FDM, and the first transmission is used for transmitting a channel or signal other than the BSC channel or signal.

10. The method according to claim 1, wherein before the configuring, by the network side device, the resource used for transmitting the BSC channel or signal, the method further comprises:
receiving, by the network side device, first capability information sent by a terminal, wherein the first capability information comprises one or more of the following:
whether the terminal supports performing the transmission of the BSC channel or signal and first transmission simultaneously, wherein the first transmission is used for transmitting a channel or signal other than the BSC channel or signal;
a Radio Frequency (RF) capability of the terminal, wherein the RF capability is used to indicate a quantity of transceiver chains supported by the terminal; or
a receiver capability of the terminal, wherein the receiver capability comprises at least one of whether multiple receivers are supported or a quantity of supported receivers.

11. A resource allocation method, comprising:
obtaining, by a terminal, resource information used for transmitting a BSC channel or signal; and
transmitting, by the terminal, the BSC channel or signal based on the obtained resource information of the BSC channel or signal,
wherein the BSC channel or signal comprises one or more of the following:
a carrier wave CW channel or signal;
a control channel or signal; or
a feedback channel or signal.

12. The method according to claim 11, wherein the obtaining, by the terminal, the resource information used for transmitting a BSC channel or signal comprises:
obtaining, by the terminal, information about a target frequency band used for transmitting the BSC channel or signal; or
obtaining, by the terminal, information about a center frequency used for transmitting the BSC channel or signal; or
obtaining, by the terminal, information about a target carrier or a target serving cell used for transmitting the BSC channel or signal.

13. The method according to claim 12, wherein the transmitting, by the terminal, the BSC channel or signal based on the obtained resource information of the BSC channel or signal comprises:
transmitting, by the terminal, the BSC channel or signal on the target carrier or the target serving cell based on target control signaling,
wherein the target control signaling is a signaling received by the terminal on a carrier or a serving cell that is not used to transmit the BSC channel or signal, or the target control signaling is a signaling received by the terminal on the target carrier or in the target serving cell.

14. The method according to claim 11, wherein the obtaining, by the terminal, the resource information used for transmitting a BSC channel or signal comprises:
obtaining, by the terminal, information about a target bandwidth part BWP used for transmitting the BSC channel or signal,
wherein the target BWP comprises a target uplink BWP or a target downlink BWP.

15. The method according to claim 14, wherein a configuration of the target BWP comprises one or more of the following:
an ID of the target BWP;
a bandwidth of the target BWP;
an SCS of the target BWP; or
a related configuration of the BSC channel or signal,
or
wherein a configuration of the target BWP does not comprise one or more of the following:
a PDCCH-related configuration;
a PDSCH-related configuration;
a PUSCH-related configuration;
a PUCCH-related configuration; or
a reference signal-related configuration.

16. The method according to claim 11, wherein the obtaining, by the terminal, the resource information used for transmitting a BSC channel or signal comprises:
obtaining, by the terminal, information about a first BWP,
wherein the first BWP is used for transmitting the BSC channel or signal, the first BWP is further used for first transmission, and the first transmission is used for transmitting a channel or signal other than the BSC channel or signal.

17. The method according to claim 16, wherein the first BWP is a BWP with a specific BWP index.

18. The method according to claim 11, wherein the transmitting, by the terminal, the BSC channel or signal comprises at least one of the following:
transmitting, by the terminal, the BSC channel or signal based on DCI signaling sent by a network side device; or
transmitting, by the terminal, the BSC channel or signal based on semi-persistent transmission configured by the network side device,
or
wherein a related configuration parameter for transmission of the BSC channel or signal comprises one or more of the following:
power information;
a frequency domain resource;
a bandwidth;
a time domain resource;
a resource cycle;
duration of a resource in each resource cycle;
a waveform;
a sending timeline of the BSC channel or signal;
a receiving timeline of the BSC channel or signal; or
HARQ-ACK resource information corresponding to the BSC channel or signal,
or
wherein the transmission of the BSC channel or signal and the first transmission satisfy at least one of TDM or FDM, and the first transmission is used for transmitting a channel or signal other than the BSC channel or signal.

19. The method according to claim 11, wherein before the obtaining, by the terminal, the resource information used for transmitting a BSC channel or signal, the method further comprises:
sending, by the terminal, first capability information, wherein the first capability information comprises one or more of the following:
whether the terminal supports performing the transmission of the BSC channel or signal and first transmission simultaneously, wherein the first transmission is used for transmitting a channel or signal other than the BSC channel or signal;
an RF capability of the terminal, wherein the RF capability is used to indicate a quantity of transceiver chains supported by the terminal; or
a receiver capability of the terminal, wherein the receiver capability comprises at least one of whether multiple receivers are supported or a quantity of supported receivers.

20. A network side device, comprising a processor and a memory storing instructions, wherein the instructions, when executed by the processor, cause the processor to perform operations comprising:
configuring a resource used for transmitting a BSC channel or signal; and
scheduling transmission of the BSC channel or signal,
wherein the BSC channel or signal comprises one or more of the following:
a CW channel or signal;
a control channel or signal; or
a feedback channel or signal.
